(19) United States
(12) Patent Application Publication
(10) Pub. No.: US 2003/0005145 A1
(43) Pub. Date: Jan. 2, 2003

(54) Network service assurance with comparison of flow activity captured outside of a service network with flow activity captured in or at an interface of a service network

(75) Inventor: Wm. Carter Bullard, New York, NY (US)

Correspondence Address: AKIN, GUMP, STRAUSS, HAUER & FELD, L.L.P., ONE COMMERCE SQUARE, SUITE 2200, 2005 MARKET STREET, PHILADELPHIA, PA, 19103, US

(73) Assignee: Qosient LLC

(21) Appl. No.: 09/879,769

(22) Filed: Jun. 12, 2001

(51) Int. Cl. G06F 15/173

(52) U.S. Cl. 709/238; 709/224

(57) ABSTRACT

A process is provided for auditing a communication session between a source connected to a first node of a service network and a destination connected to a second node of the service network. At least one of the source and destination are outside of the service network and are in communication with an interface of the service network. In the process, flow activity of selected traffic outside of the service network, as well as in or at an interface of the service network, is captured between the source and the destination at selected states and points in time during the communication session. Comparisons are conducted between the flow activity captured outside of the service network and flow activity captured in or at an interface of the service network to audit the delivery of services in the service network.

### BACKGROUND OF THE INVENTION

Network service assurance refers to the process of verifying or auditing a service network to determine if the service network is operating in the intended manner and is providing the expected service. One conventional technique of performing service assurance is to conduct packet analysis on datagrams at an interface of the service network or in the service network. Typically, a packet analyzer is used for this process. At very high data rates, such as at the gigabit level, packet analysis is not feasible. Other types of network measurement tools have been developed to measure and analyze network performance at high data rates. One such tool is the “flow meter,” also referred to as a “real time flow monitor” (RTFM). The flow meter tracks and reports on the status and performance of network streams or groups of related packets seen in an Internet Protocol (IP) traffic stream. A flow meter does not perform packet capture. That is, a flow meter is not a packet collector. Instead, a flow meter captures abstractions of the traffic, not the traffic itself.

Flow meter data or output is collected, processed and stored in or by flow collectors. One conventional flow meter and collector is known as ARGUS, and is commercially available from Qosient, LLC, New York, N.Y. ARGUS provides a common data format for reporting flow metrics such as connectivity, capacity and responsiveness, for all flows, on a per transaction basis. The network transaction audit data that ARGUS generates has been used for a wide range of tasks including security management, network billing and accounting, network operations management, and performance analysis. In a conventional configuration, one flow collector is used, and may be situated either inside a service network or outside of a service network.

One type of ARGUS record is a Flow Activity Record (FAR). The FAR provides information about network transaction flows that ARGUS tracks. A FAR has a flow descriptor and some activity metrics bounded over a time range. More specifically, each FAR has an ARGUS transaction identifier, a time range descriptor (start time and duration in microseconds), a flow descriptor and flow metrics. One basic type of flow descriptor is a flow key descriptor which includes source and destination addresses, type of protocol (e.g., TCP), and service access ports (e.g., source DSAP, SSAP). Another type of flow descriptor is a DiffServ (DS) byte or type of service (ToS) field label. Some flow metrics include src and dst packets, network and application bytes, and interpacket arrival time information. ARGUS specifications and the format of a prior art ARGUS FAR are shown in the Appendix below.

Another flow collector that may be used for network data analysis and service auditing is the “NetFlow FlowCollector,” commercially available from Cisco Systems, Inc., San Jose, Calif. NetFlow traffic describes details such as source and destination addresses, autonomous system numbers, port addresses, time of day, number of packets, bytes and type of service.

Conventional flow collectors and other types of traffic monitoring devices provide many useful service auditing functions. However, there are still many types of audit data that are not available when using conventional flow collectors and implementations thereof. The present invention uses novel configurations of flow collectors to provide enhanced network auditing functions.

### BRIEF DESCRIPTION OF THE DRAWINGS

The foregoing summary, as well as the following detailed description of preferred embodiments of the invention, will be better understood when read in conjunction with the appended drawings. For the purpose of illustrating the invention, there is shown in the drawings an embodiment that is presently preferred. It should be understood, however, that the invention is not limited to the precise arrangements and instrumentalities shown. In the drawings:

FIG. 1 is a schematic block diagram of a network system having service assurance elements in accordance with a first embodiment of the present invention;

FIG. 2 shows selected content of prior art flow activity records stored in a flow collector for use in the system of the present invention;

FIG. 3 is a schematic block diagram of a network system having service assurance elements in accordance with a second embodiment of the present invention;

FIG. 4 shows a data analysis process in accordance with the present invention which uses internal and external flow activity records to determine if a service network is providing an expected service;

FIG. 5 shows a data analysis process in accordance with the present invention which uses sequence numbers of internal and external flow collector records to determine if traffic which is missing within a service network is actually using a path outside of the service network;

FIG. 6 shows a data analysis process in accordance with the present invention which uses internal and external flow collector records to perform reachability assurance;

FIG. 7 shows a data analysis process in accordance with the present invention which uses internal and external flow collector records to perform connectivity assurance;

FIG. 8A shows a data analysis process for performing network round-trip delay analysis in accordance with the present invention;

FIG. 8B is a schematic block diagram of a network system related to FIG. 8A which shows delay times for datagrams passing through the network;

FIG. 9A shows a data analysis process for performing one-way delay analysis in accordance with the present invention; and

FIG. 9B is a schematic block diagram of a network system related to FIG. 9A which shows delay times for datagrams passing through the network.

### BRIEF SUMMARY OF THE INVENTION

A process is provided to audit a communication session between a source connected to a first node of a service network and a destination connected to a second node of the service network. At least one of the source and destination are outside of the service network and are in communication with an interface of the service network. In the process, flow activity of selected traffic outside of the service network between the source and the destination is captured at selected states and points in time during the communication session. The flow activity includes a flow descriptor and corresponding time data for selected datagrams outside of the service network that are intended to be placed in the service network. Also, flow activity of selected traffic in or at an interface of the service network between the source and the destination is captured at selected states and points in time during the communication session. This flow activity includes a flow descriptor and corresponding time data for selected datagrams placed in the service network. The flow descriptors and their corresponding time data are used to identify flow activity outside of the service network that corresponds to flow activity in or at an interface of the service network.

### DETAILED DESCRIPTION OF THE INVENTION

Certain terminology is used herein for convenience only and is not to be taken as a limitation on the present invention. In the drawings, the same reference letters are employed for designating the same elements throughout the several figures.

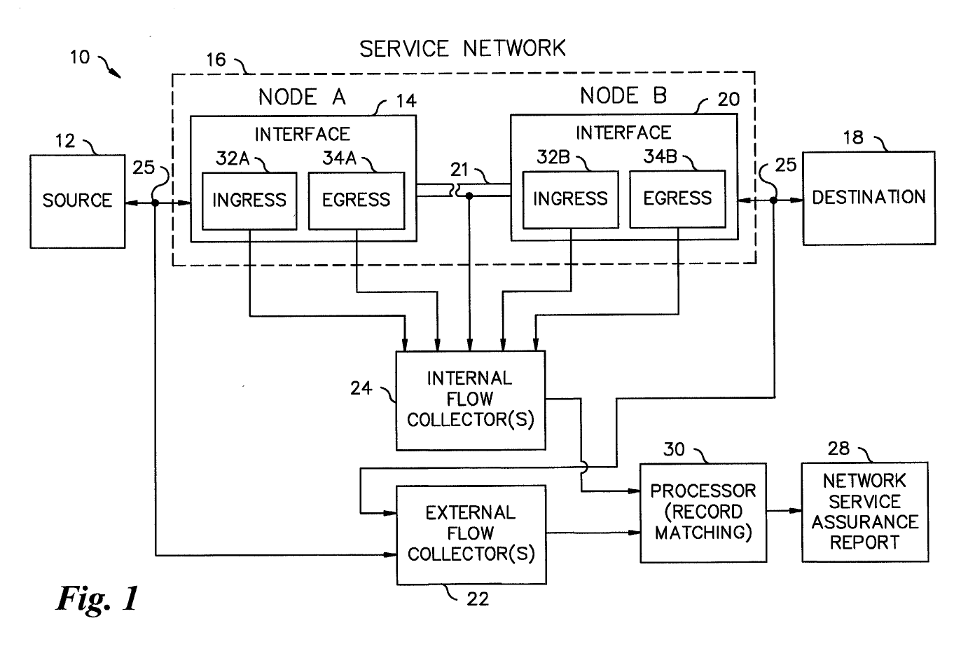

FIG. 1 shows a system 10 in accordance with a preferred embodiment of the present invention. The system 10 audits a communication session between a source 12 connected to a first node 14 (node A) of a service network 16 and a destination 18 connected to a second node 20 (node B) of the service network 16. Nodes A and B of the service network 16 are connected to each other via a communication path 21. At least one of the source 12 and the destination 18 are outside of the service network 16 and are in communication with an interface of the service network 16. In FIG. 1, the source 12 and the destination 18 are outside of the service network 16.

Nodes A and B abstractly represent the ingress and egress interfaces for the flow into and out of the service network 16. Thus, for example, node A may be one physical node, or may be a plurality of nodes such as two unidirectional nodes which together allow for bidirectional flow. If node A represents a plurality of nodes, the nodes may be in one physical location or facility, or may be physically dispersed among plural locations or facilities.

Flow activity of selected traffic outside of the service network 16 between the source 12 and the destination 18 is captured at selected states and points in time during the communication session. The captured flow activity includes a flow descriptor for selected datagrams outside of the service network 16 that are intended to be placed in the service network 16. Flow activity of selected traffic in or at an interface of the service network 16 between the source 12 and the destination 18 is also captured at selected states and points in time during the communication session. This captured flow activity includes a flow descriptor for selected datagrams placed in the service network 16. The flow activity outside of the service network 16 is stored in time-stamped flow activity records of one or more external network flow collectors 22. The flow activity in or at the interface of the service network 16 is stored in time-stamped flow activity records of one or more internal network flow collectors 24. The records are used to audit the delivery of services in the service network 16. The internal network flow collector(s) capture flow activity at an interface or edge of the service network 16 (see the data lines extending from the ingress and egress of the nodes A and B), as well as flow activity in the service network 16 (see the data line extending from the communication path 21).

FIG. 1 shows a single external flow activity collector 24 and a single internal flow activity collector 22. In practice, there may be a plurality of flow activity collectors capturing flow activity at different locations in a service network, at an interface of the service network 16, or outside of the service network 16. If so, then the flow records may be merged prior to analysis. However, the internal flow activity records are kept separate from the external flow activity records, as conceptually shown in FIG. 1. For illustration purposes and to simplify the explanation of the invention concepts, the subsequent explanations will refer to a single external flow collector 22 and a single internal flow collector 24.

In FIG. 1, the external flow collector 22 receives its data from flow record collection points 25 outside of the service network 16. Preferably, the flow record collection points 25 are located at the ingress/egress of the respective source 12 and destination 18. The further away that the collection points 25 are located from the source and destination ingress/egress, the less reliable the data.

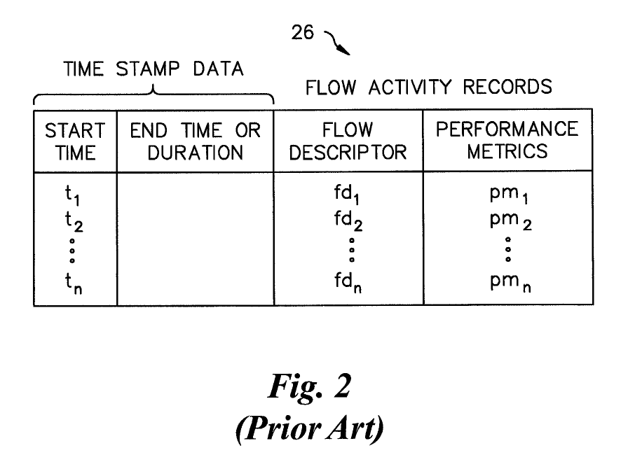

FIG. 2 shows selected content of flow activity records 26 stored in the flow collectors 22 and 24. Each flow activity record entry has time stamp data, a flow descriptor, and performance metrics of the flow. The time stamp data includes a start time, and a stop time or a duration of time from the start time. In a bidirectional flow collector, the flow descriptor accounts for corresponding ingress and egress flows. In a unidirectional flow collector, the flow descriptor accounts for only one flow (either ingress or egress), and contains only the performance metrics for the one flow. To obtain the complete flow record when using unidirectional flow collectors, records from the two unidirectional flow collectors (each capturing one-half of the flow) must be correlated or merged. The scope of the present invention includes embodiments that use bidirectional and unidirectional flow collectors.

The methods used by a flow collector to capture flow activity are well-known in the prior art. For the purposes of the present invention, a flow collector captures sufficient flow activity information so that the same network activity, captured by multiple independent flow collectors along a given network path, can be unambiguously identified and matched. Flow activity timestamps must represent the time of observation of the same network event, so that comparisons of flow activity timestamps from multiple flow collectors has relevance. To support this requirement, flow collectors may use flow state and flow duration characteristics to determine when to generate flow activity records. Although not a strict requirement, the flow descriptors can include sufficient identifying information so that making the determination that the reported network events are indeed the same, is possible. Examples of flow states include flow start, flow continuance and flow stop.

The types of flow activity records stored in the flow collectors 22 and 24 are well-known in the prior art. It is also well-known to use time data and flow descriptors to identify flow activity within a single flow collector. For example, such analysis may show that flow descriptor fd₁ relates to a datagram X that is communicated from the source 12 to the destination 18, and to a datagram Y that is communicated from the destination 18 to the source 16 in response to the datagram X. The resulting flow activity record may be analyzed to obtain selected performance metrics of the service network 16. Also, if no bidirectional traffic is seen for the flow descriptor fd₁, this information may be used to detect a problem in the service network 16. For example, the destination 18 may not have received the datagram X associated with flow descriptor fd₁, or there may be some communication problem at node B. Although it is known to analyze flow activity records in a single flow collector, heretofore, such records have not been used to audit service networks and to obtain performance metrics of service networks by comparing flow activity records captured outside of a service network with flow activity records captured in or at an interface of a service network. The processes described below detect potential problems in service networks that were not possible to detect using conventional flow collector analysis techniques.

Flow descriptors and performance metrics are available at flow collection points 25 external to a service network and at the interfaces of the service network 16. However, for some services, flow descriptors are not available in the service network, such as at points along the communication path 21. Performance metrics may be available at such points, even when flow descriptors are not available. For some services, the flow descriptors at the points along the communication path 21 may be indirectly obtained by a mapping of other flow data that can be derived from the datagram payload. Unless there is a particular need to obtain flow activity records in the service network, such as when differentiated analysis for network service debugging and troubleshooting is required, the preferred flow capture point for service network flow is at the service interfaces, such as the ingress and egress of nodes A and B.

Referring again to FIG. 1, the data in the internal and external flow collectors 22 and 24 are provided to a processor 30 which performs record matching using conventional techniques. Once related internal and external flow activity records are identified, at least the following types of information may be obtained:

(1) It may be determined if the service network 16 is carrying the traffic monitored by the external flow collector 22. To obtain this information, it is determined as to whether selected flow activity record entries in the external flow collector 22 corresponds to flow activity record entries in the internal flow collector 24. If so, then the datagrams associated with the flow activity record entries in the external flow collector 22 have successfully passed through the service network 16, and thus have received a desired service. In the example of FIG. 1, the processor 30 compares records from the external flow collector 22 with the records of the internal flow collector 24.

(2) It may be determined if the service network is not carrying the traffic monitored by an external flow collector 22. To obtain this information, it is determined if selected flow activity record entries in the external flow collector 22 do not correspond to any flow activity record entries in the internal flow collector 24. If so, then the datagrams associated with the flow activity record entries in the external flow collector 22 may not have passed through the service network 16, and thus may not have received a desired service. The comparisons are performed in a similar manner as described above.

(3) It may be determined if the service network is carrying only the ingress or egress traffic and is thereby operating in a half-duplex mode. To obtain this information, it is determined if flow activity record entries in the external flow collector 22 corresponds to one, but not both of, ingress and egress flow activity record entries in the internal flow collector 24. If so, then the datagrams associated with the flow activity record entries in the external flow collector 22 may not have passed bidirectionally through the service network 16.

(4) It may be determined if the service network 16 is carrying only a portion of the traffic monitored by the external flow collector 22. To obtain this information, it is determined as to whether selected flow activity record entries in the external flow collector 22 corresponds to only some (but not all) of the ingress and egress flow activity record entries in the internal flow collector 24. If so, then only some of the datagrams associated with the flow activity record entries in the external flow collector 22 have successfully passed through the service network 16, and thus have received a desired service. In the example of FIG. 1, the processor 30 compares records from the external flow collector 22 with the records of the internal flow collector 24.

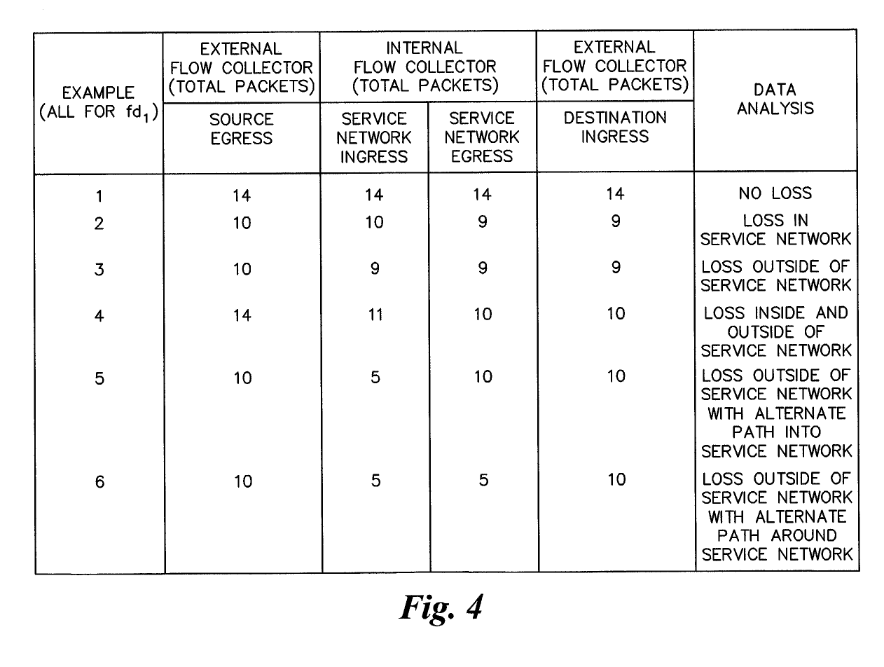

(5) It may be determined if the service network is providing the expected service. Consider an example wherein a customer is paying for the use of a service network 16 with a guaranteed packet loss of less than 0. 10%. FIG. 4 shows four different examples wherein record matching has been performed on a flow activity record associated with flow descriptor fd₁. Referring to FIG. 1, flow is captured at the source egress and the destination ingress by an external flow collector 22, and at the service network ingress 32_{A} and the service network egress 34_{B} by the internal flow collector 24. The performance metric of “total packets” is compared among the records. In all of the examples, it is determined that the service network is carrying the traffic associated with the flow descriptor fd₁ because the flow descriptor fd₁ exists in each of the flow records. In the first example, it is discovered that the service network 16 is not experiencing any packet loss. In the second example, it is discovered that the service network 16 experienced a packet loss of about 10%, which is significantly greater than the expected service. In the third example, it is discovered that the service network did not experience packet loss, but that there was packet loss of about 10% outside of the service network. In the fourth example, it was discovered that there was loss inside and outside of the service network with the service network causing about 10% of the total packet loss. In a practical example, many different flow activity records (fd₁, fd₁, . . . fdₙ) would be compared in the same manner as described above to determine specific packet loss in specific points of the service network. In this manner, an expected service of the network, here, “packet loss of less than 0.10%,” may be determined by using the present invention.

(6) When packet loss is detected, it may be determined if the apparent packet loss is actually the result of the flow using multiple paths. Referring again to FIG. 4, in the fifth example, it is discovered that there is an apparent packet loss outside of the service network and that there is an alternate path into the service network, since the original 10 packets were detected at the service network egress when only 5 packets were detected at the service network ingress. In the sixth example, it is discovered that there is an apparent packet loss outside of the service network 16 and that there is an alternate path around the service network 16, since the original 10 packets were detected at the destination egress, but were not detected at the service network ingress or egress.

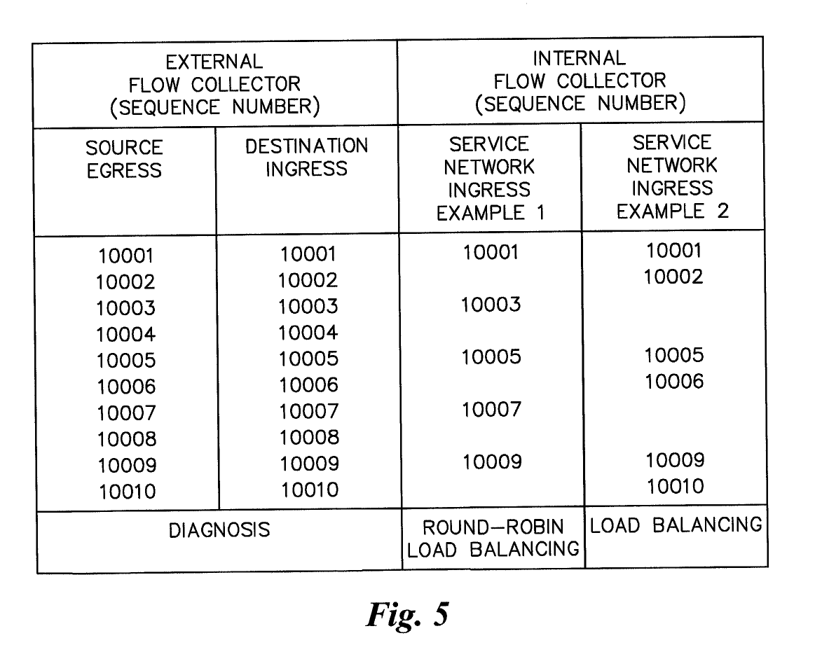

(7) The loss pattern or loss distribution of sequence numbers may be used to strengthen the determination that apparent loss is actually a path outside of the service network. In FIG. 5, the processor 30 has extracted the sequence numbers of selected flow activity records from the flow descriptors at the source egress and the destination ingress in the external flow collector 22 and at the service network ingress and egress in the internal flow collector 24. The sequence numbers at the source egress and destination ingress are continuous from 10001 to 10010. However, in the first example, the sequence numbers at the service network ingress skip every even number. Thus, in addition to discovering that the service network is not carrying half of the traffic, it can be presumed that the service network is performing round-robin load balancing by routing one-half of the traffic outside of the service network 16, presumably via the open and exposed Internet. In the second example, the service network 16 is performing load balancing by routing one-third of the traffic outside of the service network 16. Any deterministic pattern or non-random distribution of loss may be used to uncover the systematic use of paths outside of the service network 16, and thus the loss of expected service.

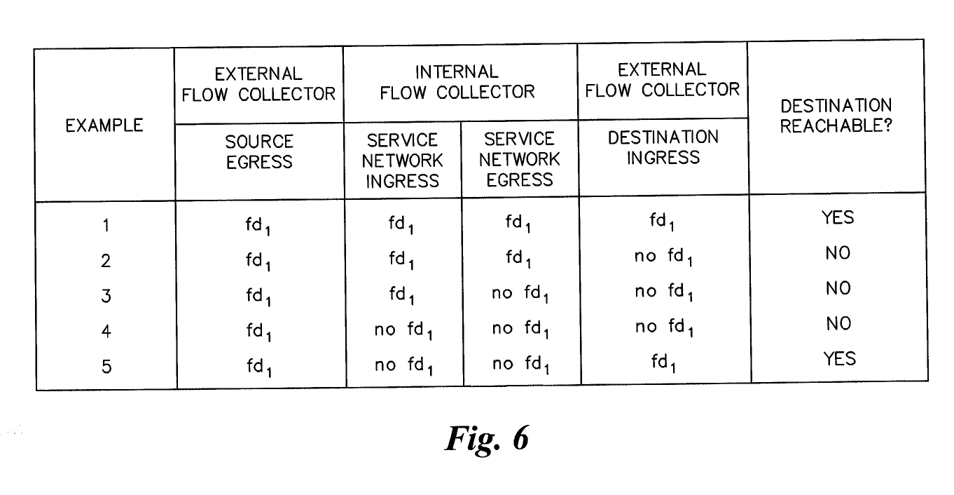

(8) Network service availability, such as “reachability assurance” may be analyzed. “Reachability” refers to whether packets sent from one or more sources can be received at a particular destination, whether or not the packets take an alternative path. If packets can be received at the particular destination, then the destination is said to be “reachable.” If packets cannot be received at the particular destination, then the destination is said to be “not reachable.” Referring to FIGS. 1 and 6, the processor 30 matches up a particular flow descriptor, here fd₁, from the flow descriptors at the source egress and the destination ingress in the external flow collector 22 and at the service network ingress and egress in the internal flow collector 24. In the first example, there is an fd₁ record from all four flow capture points. Thus, the destination 18 is reachable from the source 12 via the service network 16. In the examples 2-4, the destination 18 is not reachable. In the example 5, the destination 18 is reachable, but the packets are not passing through the service network 16. In a practical example, many different flow activity records (fd₁, fd₁, . . . fdₙ) would be compared in the same manner as described above before a determination is made that a particular destination is not reachable.

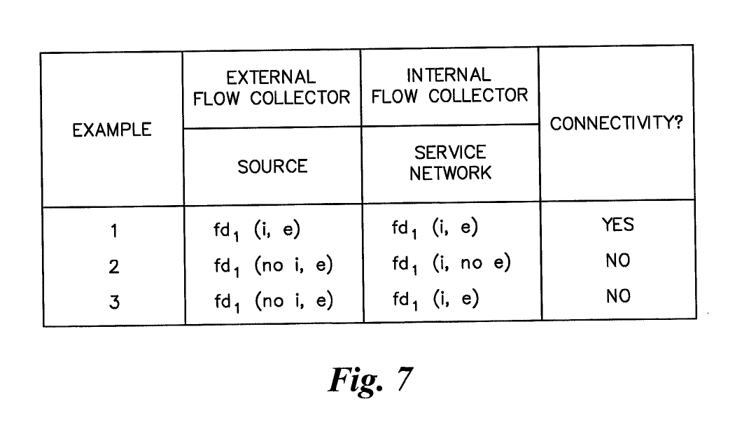

(9) Connectivity assurance may be analyzed. When a packet is sent from the source 12 to the destination 18, a response is sent from the destination 18 to the source 12 for those network transactions that involve connectivity. In a bidirectional flow collector, the flow descriptor accounts for corresponding ingress and egress flows which relate to the sending of the packet from the source to the destination (egress) and the receipt of a response at the source from the destination (ingress). In a unidirectional flow collector, the flow descriptor accounts for only one flow (either ingress or egress). To obtain the complete flow record when using unidirectional flow collectors, records from two unidirectional flow collectors (each capturing one-half of the flow) must be correlated or merged. In either case, a flow record will have an ingress and an egress portion. Connectivity at a specific point in the network exists when a flow record includes both ingress and egress portions. Connectivity does not exist when a flow record is missing one of the ingress or egress portions of the record. Referring to FIGS. 1 and 7, the processor 30 matches up a particular flow descriptor, here fd₁, from the flow descriptors captured at the source 12 in the external flow collector 22, and from the corresponding flow descriptors captured at an interface of the service network 16 in the internal flow collector 24. In the first example, each flow record has an ingress and egress portion, and thus connectivity exists. In the second example, each flow record has only an ingress or an egress portion, and thus connectivity does not exist. In the second example, the source 12 may be sending packets to the destination 18 through the service network 16, but the destination 18 is not providing any response, and thus connectivity does not exist. In the third example, the external flow collector record has only an egress portion, and the corresponding internal flow collector record has both an ingress and egress portion. Thus, connectivity does not exist. In a practical example, many different flow activity records (fd₁, fd₁, . . . fdₙ) would be compared in the same manner as described above before a determination is made that connectivity does not exist between a particular source/destination pair.

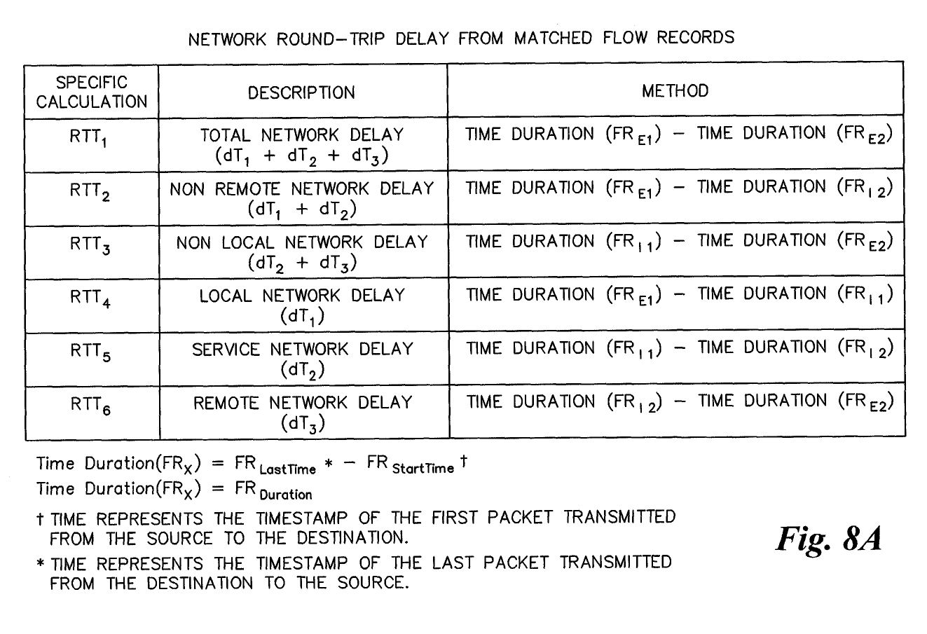

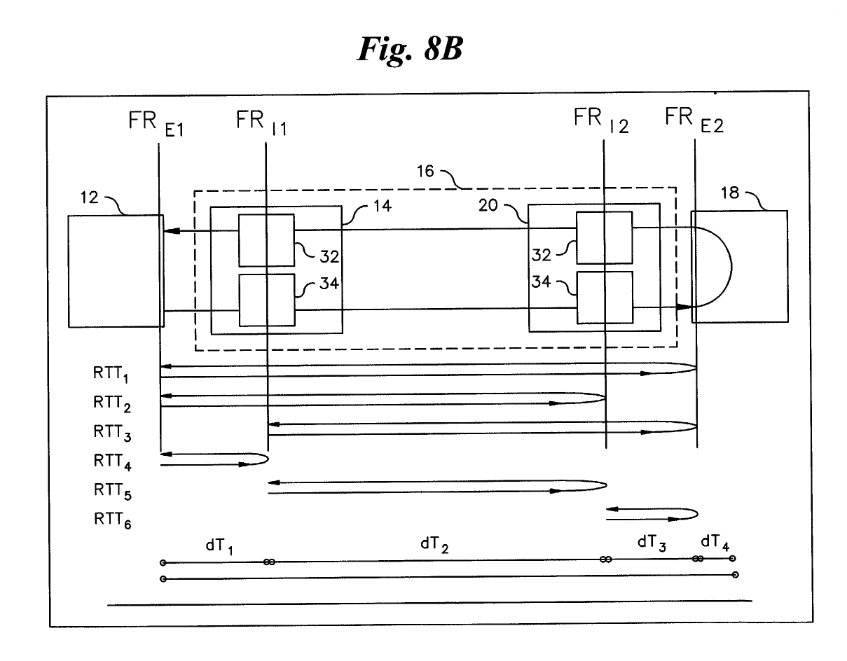

(10) Round-trip delay may be analyzed. FIG. 8A shows a data analysis process for performing network round-trip delay analysis in accordance with the present invention. FIG. 8B is a schematic block diagram of a network system related to FIG. 8A which shows delay times for datagrams passing through the network. Time stamp data of matched flow records from internal and external flow collectors (not shown, but represented by capture points FR_{I1}, FR_{I2} and FR_{E1}, FR_{E2}, respectively) may be used to determine various network delay parameters, such as non-remote network delay, non-local network delay, local network delay, and remote network delay. Time stamp data of matched flow records from solely internal or solely external flow collectors may be used to determine other network delay parameters, such as total network delay and service network delay.

With respect to FIGS. 8A and 8B, the service network is element 16, the local network comprises the sum of network components between elements 12 and 14, and the remote network comprises the sum of network components between elements 20 and 18.

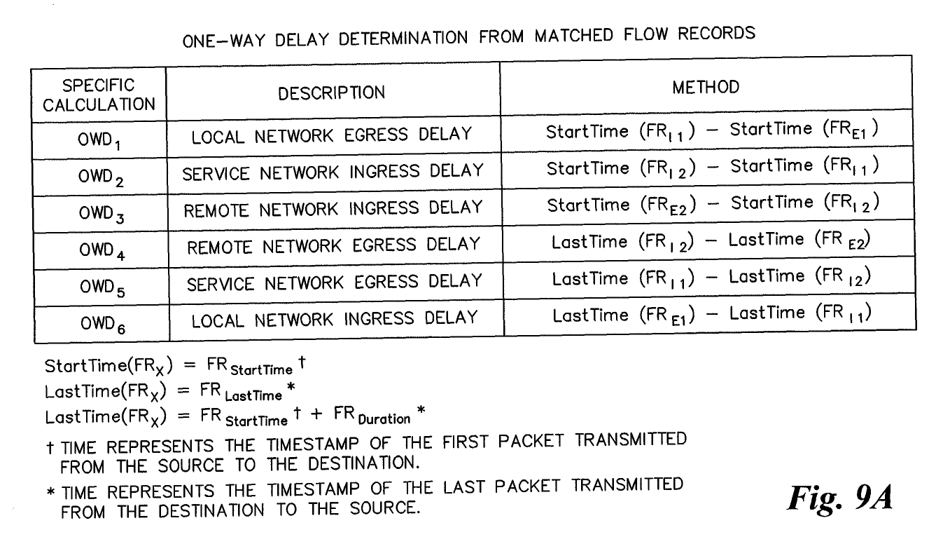

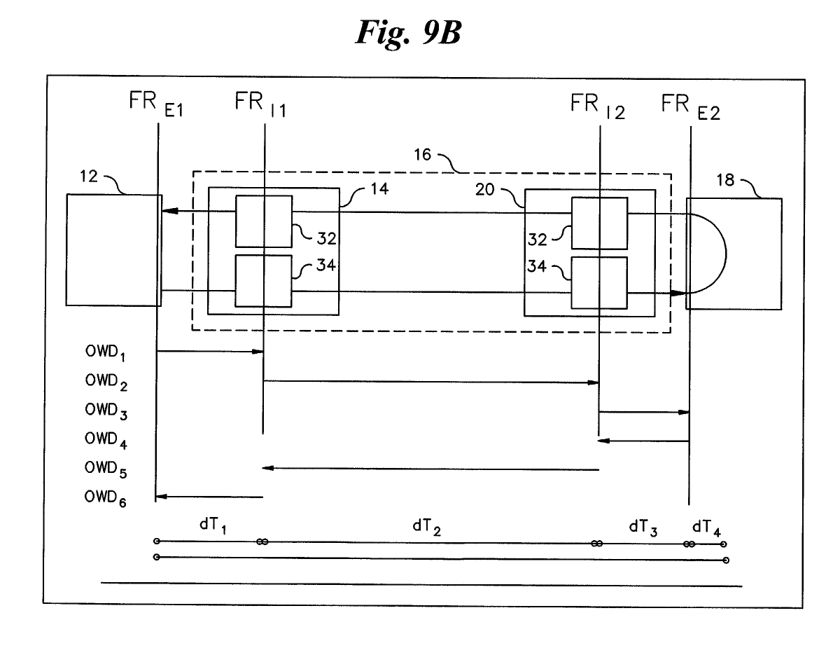

(11) One-way delay may be analyzed. FIG. 9A shows a data analysis process for performing one-way delay analysis in accordance with the present invention. FIG. 9B is a schematic block diagram of a network system related to FIG. 9A which shows delay times for datagrams passing through the network. Time stamp data of matched flow records from internal and external flow collectors (not shown, but represented by capture points FR_{I1}, FR_{I2} and FR_{E1}, FR_{E2}, respectively) may be used to determine various one-way delay parameters, such as local network egress delay, remote network ingress delay, remote network egress delay, and local network ingress delay. Time stamp data of matched flow records from solely internal or solely external flow collectors may be used to determine other one-way delay parameters, such as service network ingress delay and service network egress delay.

Similar techniques may be used to analyze variations of one-way delay, such as jitter.

With respect to FIGS. 9A and 9B, the service network is element 16, the local network comprises the sum of network components between elements 12 and 14, and the remote network comprises the sum of network components between elements 20 and 18. Also, in FIG. 9B, all flow meters must be time synchronized. Conventional methods may be used for the time synchronization.

The results of the various comparisons and analyses described above are provided to a network service assurance report 28, shown in FIG. 1.

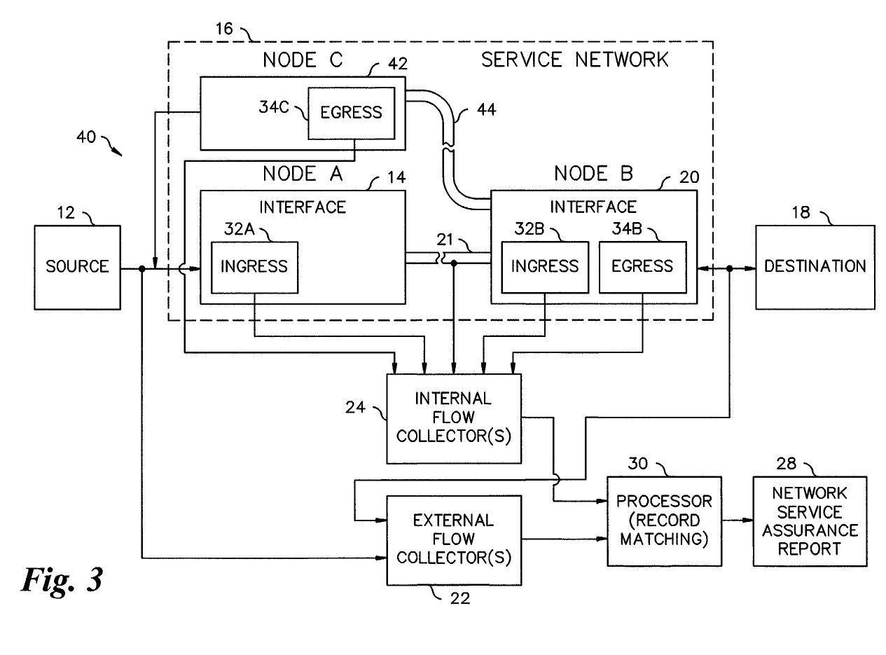

The scope of the present invention includes embodiments wherein the service network 16 is asymmetric or symmetric, and wherein the nodes are unidirectional or bidirectional. FIG. 3 shows a system 40 which is similar to system 10, except that node A is unidirectional and the service network 16 is asymmetric. Another unidirectional node 42 (labeled as node C) is provided. Datagrams to be sent from the source 12 to the destination 18 flow through node A and the communication path 21, whereas datagrams sent from the destination 18 to the source 12 flow through node C via an additional communication path 44. The flow activity at node C is also captured by the internal flow collector 24. Alternatively, the nodes A and C may be bidirectional, and, thus may each include an ingress and an egress.

It is not necessary to obtain flow activity records from all of the flow capture points shown in FIGS. 1 and 3 to practice the present invention. For example, referring to FIG. 3, to determine if the service network 16 is carrying the bidirectional traffic seen at the source 12 as monitored by the external flow collector 22, it is only necessary to match flow activity records captured at the source (stored in the external flow collector 22) with flow activity records captured from node A and node C (stored in the internal flow collector 24), or with the flow activity records captured from node B (also stored in the internal flow collector 24). The flow activity captured at node B thus provides redundant information to the flow activity captured at nodes A and C.

In the preferred embodiment of the present invention, flow activity is captured by a flow meter, stored in time-stamped flow activity records of flow collectors, and then the flow activity record entries are used in subsequent correlating, merging, comparing and processing steps. However, the scope of the present invention includes embodiments without flow collectors, as well as embodiments without flow collectors that use elements which perform functions similar to flow collectors.

The present invention may be implemented with any combination of hardware and software. If implemented as a computer-implemented apparatus, the present invention is implemented using means for performing all of the steps and functions described above.

The present invention can be included in an article of manufacture (e.g., one or more computer program products) having, for instance, computer useable media. The media has embodied therein, for instance, computer readable program code means for providing and facilitating the mechanisms of the present invention. The article of manufacture can be included as part of a computer system or sold separately.

Changes can be made to the embodiments described above without departing from the broad inventive concept thereof. The present invention is thus not limited to the particular embodiments disclosed, but is intended to cover modifications within the spirit and scope of the present invention.

[image]

[image]

[image]

[image]

[image]

[image]

[image]

[image]

What is claimed is:

1. A method of auditing a communication session between a source connected to a first node of a service network and a destination connected to a second node of the service network, wherein at least one of the source and destination are outside of the service network and are in communication with an interface of the service network, the method comprising:
(a) capturing flow activity of selected traffic outside of the service network between the source and the destination at selected states and points in time during the communication session, including a flow descriptor and corresponding time data for selected datagrams outside of the service network that are intended to be placed in the service network;
(b) capturing flow activity of selected traffic in or at an interface of the service network between the source and the destination at selected states and points in time during the communication session, including a flow descriptor and corresponding time data for selected datagrams placed in the service network; and
(c) using the flow descriptors and their corresponding time data to identify flow activity outside of the service network that corresponds to flow activity in or at an interface of the service network.

2. The method of claim 1 wherein the flow activity captured in steps (a) and (b) further includes total packets for the selected datagrams, the method further comprising:
(d) comparing the total packets of selected flow activity outside of the service network with the total packets in corresponding flow activity in or at a service interface of the service network to perform packet loss data analysis.

3. The method of claim 2 wherein step (d) further comprises comparing the total packets of selected flow activity outside of the service network with the total packets in corresponding flow activity in or at a service interface of the service network to determine at least one of the conditions of: no loss, loss in the service network, loss outside of the service network, and loss inside and outside of the service network.

4. The method of claim 2 wherein step (d) further comprises comparing the total packets of selected flow activity outside of the service network with the total packets in corresponding flow activity in or at a service interface of the service network to determine at least one of the conditions of: an alternate path into the service network and an alternate path around the service network.

5. The method of claim 1 further comprising:
(d) storing the flow activity outside of the service network in time-stamped flow activity records of one or more external network flow collectors, and storing the flow activity in or at the interface of the service network in time-stamped flow activity records of one or more internal network flow collectors, wherein step (c) is performed using the records in the external and internal network flow collectors.

6. The method of claim 1 wherein steps (a) and (b) are performed by a flow meter.

7. The method of claim 1 further comprising:
(d) determining if selected flow activity captured outside of the service network corresponds to flow activity captured in or at an interface of the service network, and, if so, then the datagrams associated with the selected flow activity captured outside of the service network have successfully passed through the service network, and thus have received a desired service.

8. The method of claim 1 further comprising:
(d) determining if selected flow activity captured outside of the service network does not correspond to any flow activity captured in or at an interface of the service network, and, if so, then the datagrams associated with the selected flow activity outside of the service network may not have passed through the service network, and thus may not have received a desired service.

9. The method of claim 1 wherein ingress and egress flow activity is captured at a service interface in the service network, the method further comprising:
(d) determining if selected flow activity captured outside of the service network corresponds to one, but not both of, ingress and egress flow activity captured at the ingress and egress service interface in the service network, and, if so, then the datagrams associated with the selected flow activity captured outside of the service network may not have passed bidirectionally through the service network, and thus may not have received a desired service.

10. The method of claim 1 wherein ingress and egress flow activity is captured at a service interface in the service network, the method further comprising:
(d) determining if selected flow activity captured outside of the service network corresponds to only some, but not all, of ingress and egress flow activity captured at the ingress and egress service interface in the service network, and, if so, then only some of the datagrams associated with the selected flow activity captured outside of the service network have successfully passed through the service network, and thus may not have received a desired service.

11. The method of claim 1 wherein the flow activity captured in steps (a) and (b) further includes a mathematical representation of the sequence number loss distribution for the selected datagrams, the method further comprising:
(d) comparing the sequence number loss distribution of flow activity captured outside of the service network with the sequence number loss distribution in corresponding flow activity in or at an interface of the service network to detect whether there is a deterministic pattern of missing sequence numbers in the flow activity captured in or at an interface of the service network that indicates that the service network is performing load balancing, and is thus not passing selected traffic through the service network.

12. The method of claim 1 further comprising:
(d) determining if selected source egress and destination ingress flow activity captured outside of the service network corresponds to flow activity captured in or at an interface of the service network, and, if so, then the destination is determined to be reachable from the source via the service network.

13. The method of claim 1 further comprising:
(d) determining if selected ingress and egress flow activity captured outside of the service network corresponds to both ingress and egress flow activity captured in or at an interface of the service network, and, if so, then connectivity is determined to exist between the source and the destination.

14. The method of claim 1 further comprising:
(d) calculating time duration data of the identified flow activity outside of the service network that corresponds to flow activity in or at an interface of the service network; and
(e) using the time duration data to determine one or more round-trip delay parameters.

15. The method of claim 1 further comprising:
(d) calculating time duration data of the identified flow activity outside of the service network that corresponds to flow activity in or at an interface of the service network; and
(e) using the time duration data to determine one or more one-way delay parameters.
